(19) United States
(12) Patent Application Publication
(10) Pub. No.: US 2014/0074735 A1
(43) Pub. Date: Mar. 13, 2014

(54) METHOD FOR A LEGAL PROFESSIONAL TO OBTAIN A CLIENT

(71) Applicant: Trevor Garrison, Berkley, MI (US)

(72) Inventor: Trevor Garrison, Berkley, MI (US)

(21) Appl. No.: 13/612,950

(22) Filed: Sep. 13, 2012

(51) Int. Cl. G06Q 50/18

(52) U.S. Cl. 705/311

(57) ABSTRACT

Disclosed is a method for a legal professional to obtain a potential client to represent in a legal matter. The method includes presenting a potential client with an interface allowing the potential client to input information relating to a legal matter. The method further includes presenting the potential client with a retainer agreement, accessible via an electronic device of the client, such that the potential client can accept the retainer agreement and hire the legal professional via the electronic device.

### BACKGROUND

There are known methods allowing a potential client to contact a legal professional, such as an attorney, using the internet. Some methods include application software (e.g., an “app” accessible via the internet, or in the form of an “app” downloaded onto a mobile phone) that allows a potential client to search for legal professionals within a particular area of law or within a particular geographical location. In these methods, it is up to the potential client to make the initial contact with a potential legal professional based on the results of the search.

In other methods, an app prompts a potential client to fill out basic information relating to their particular legal matter, and that information is forwarded to a legal professional for review. The legal professional must then follow up with the potential client to discuss potentially going forward with the matter.

### SUMMARY

A method for a legal professional to obtain a client to represent in a legal matter according to one non-limiting embodiment of the present disclosure includes presenting a potential client with an interface allowing the potential client to input information relating to a legal matter. The method further includes presenting the potential client with a retainer agreement, accessible via an electronic device of the potential client, such that the potential client can accept the retainer agreement and hire the legal professional via the electronic device.

These and other features of the present disclosure can be best understood from the following drawings and detailed description.

### BRIEF DESCRIPTION OF THE DRAWINGS

The drawings can be briefly described as follows:

FIG. 1 illustrates an example system capable of carrying out the method of the present disclosure.

FIG. 2 illustrates an example method for a legal professional to obtain a client.

FIG. 3A illustrates a front view of an example electronic device that can be used by a potential client, here illustrated as a mobile phone. FIG. 3A further illustrates an example interface for a potential client to input certain information relating to a particular legal matter.

FIG. 3B illustrates a rear view of the example electronic device of FIG. 3A.

FIG. 4 illustrates an example of the manner in which a retainer agreement and a legal fee can be presented to a potential client using the method of this disclosure.

FIG. 5 illustrates an example interface for a potential client to input payment information.

FIG. 6 schematically illustrates the manner in which both the client and the legal professional can be notified when the client has retained the legal professional.

### DETAILED DESCRIPTION

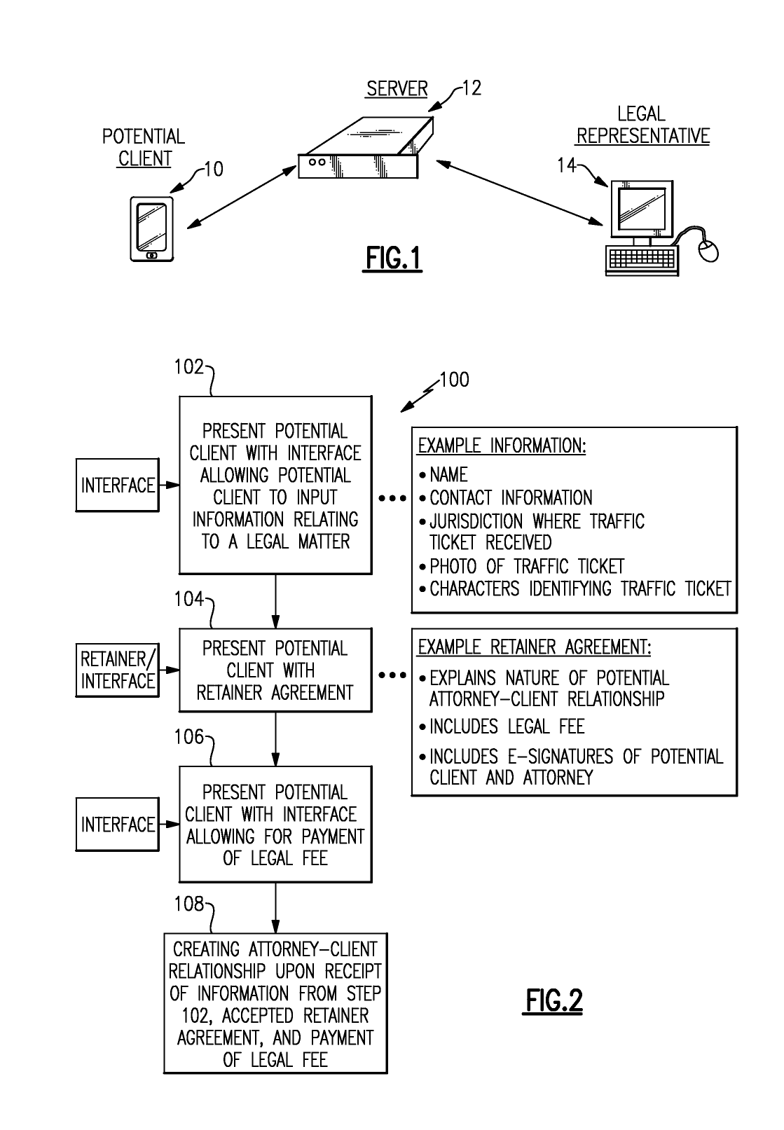

This disclosure relates to a method for a legal professional to obtain potential clients. In the exemplary method, potential clients can hire the legal professional using only an electronic device 10, such as a mobile phone. Other electronic devices are also contemplated, including, but not limited to, computers, tablets, or any other device capable accessing the internet. The implementation of the method according to the present disclosure involves a potential client accessing application software (e.g., an “app” accessible via the internet, or in the form of an “app” downloaded onto a mobile phone) by way of an electronic device 10 of FIG. 1.

As illustrated in FIG. 1, the electronic device 10 is in communication with a server 12, which is in turn accessible by a legal professional, in this example, by way of a computer 14 of the legal professional.

While an electronic device 10 is pictured, the potential client could use any other type of electronic device, such as a personal computer. Similarly, the legal professional could use any other type electronic device, such as a mobile phone, tablet, or any other device capable of accessing the internet. Further, while a server 12 is illustrated, this disclosure could be implemented without a server, using known methods of communicating between two electronic devices and storing data.

As used herein, the electronic device 10, the server 12, and the computer 14, should be understood to include the components typical of such devices, as is known in the art. For example, the electronic device 10, server 12, and computer 14 should be known to include a CPU, memory (RAM and ROM), various inputs and outputs, etc. The electronic device 10, the server 12, and the computer 14 can communicate with one another by known networking methods, such as wireless connections.

FIG. 2 illustrates an example method 100 according to this disclosure. Should a potential client desire to hire a legal professional for a particular legal matter, the client can access an app of the legal professional, again, such as by way of accessing a website (e.g., including a mobile website) or by way of an app downloaded onto the electronic device 10. Within the app, at 102, the client is presented with an interface allowing the potential client to input information relating to their particular legal matter. It should be understood that the software associated with the app can be modified to change the interface, as desired.

In one example, the potential legal matter can include a traffic ticket that the potential client has recently received. The potential client may input information such as their name, contact information, and the jurisdiction in which they received their traffic ticket. The interface, in a further example, allows the client to upload a photo of their traffic ticket. It should be understood that other, additional information that may be relevant can be collected.

Alternatively or in addition, the interface allows the client to input a series of characters identifying their particular traffic ticket. The legal professional can later use this information to identify the particular traffic ticket when representing the potential client in court, for example. While this application mentions traffic tickets specifically, this disclosure extends to all types of legal matters and is not limited to traffic tickets.

Once the information is submitted at 102, the potential client is presented with a retainer agreement at 104. The retainer agreement, in one example, explains the nature of the potential legal professional-client relationship, includes information regarding a legal fee, and includes e-signatures of the potential client and legal professional. The retainer agreement is capable of being accepted by the client by way of the electronic device 10, in one example by the client clicking an “accept” button provided in the interface of the electronic device 10. Further, the retainer agreement can be specific to a jurisdiction of the potential client's traffic ticket, depending on the rules and laws governing legal professional-client relationships in that jurisdiction.

Should the potential client accept the retainer agreement, the potential client would then be prompted, at 106, to pay the legal fee outlined in the retainer. In one example, this involves the client entering certain payment information, such as credit card information, or some other type of web-based payment service. Upon acceptance of the retainer agreement and payment of the legal fee, a legal professional-client relationship, such as an attorney-client relationship, is created at 108. To this end, there could be a fail-safe built into the retainer agreement such that if the payment information is invalid, or if the legal fee is not ultimately paid, then the legal professional-client relationship would be terminated. In another example, the client is required to enter payment information before, or concurrent with, accepting the retainer agreement.

Optionally, it could be possible for the legal professional to reject a particular potential client, at a point before 108, for various reasons. Ideally, however, the efficiency provided by this disclosure will reduce, or eliminate, the need for a legal professional to reject a particular potential client.

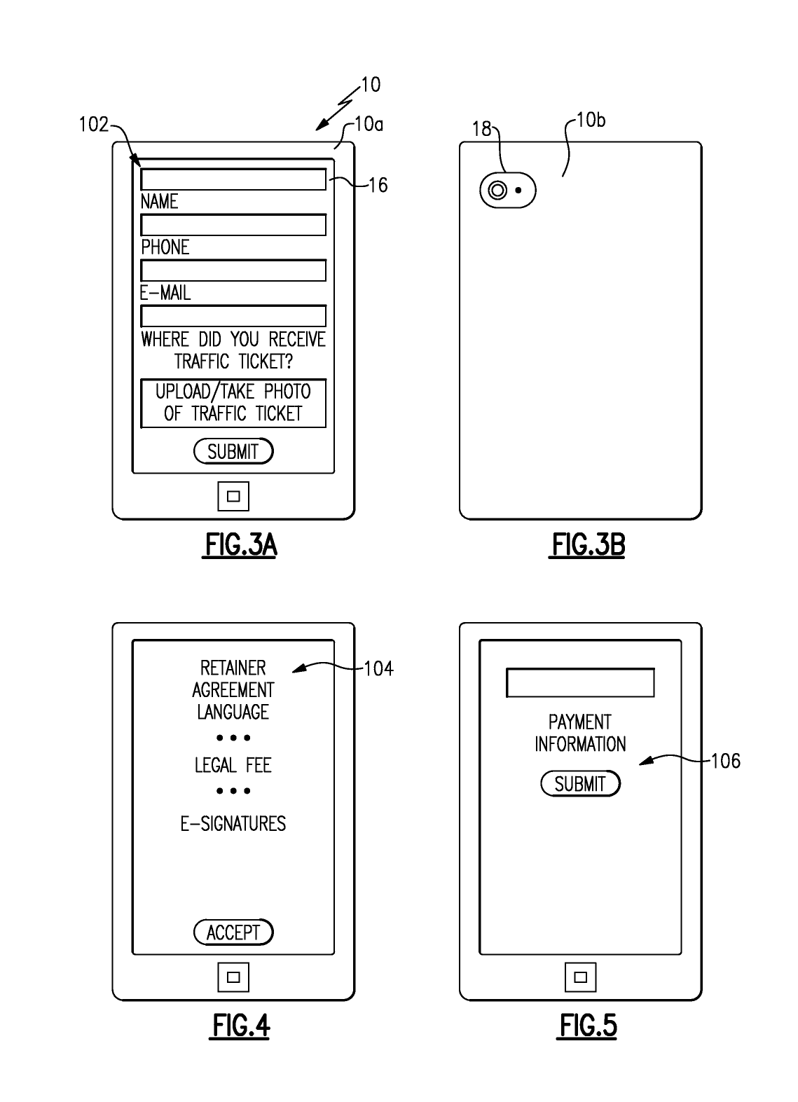

FIGS. 3A-3B, with continued reference to FIG. 2, detail an example electronic device 10 a potential client can use to retain a legal professional. As is typical of most current electronic devices, the electronic device includes a touchscreen 16 on a front side 10a thereof, and a camera 18 on the rear side 10b. FIG. 3A further illustrates an example interface that could be presented to a potential client, allowing the potential client to input the information requested in step 102. In one example, the potential client can upload a media file, such as a photo, of their traffic ticket stored in the memory of the electronic device 10. In another example, the app is configured to allow the client to take a photo of the traffic ticket with the camera 18, and that photo could be automatically uploaded.

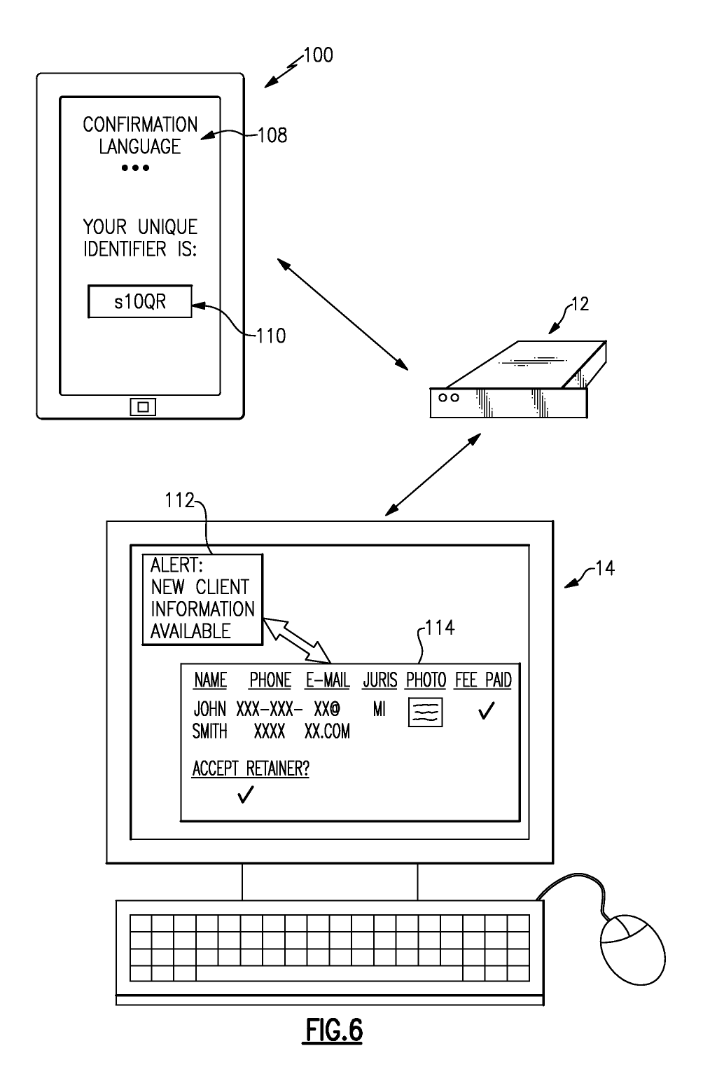

FIGS. 4 and 5 illustrate examples of the manner in which a client would be presented with the information described relative to steps 104 and 106, respectively. In the illustrated example, a legal professional-client relationship will be created upon the potential client selecting “Accept,” in FIG. 4, and upon submitting (via the “Submit” button, in FIG. 5) valid payment information.

Turning to FIG. 6, upon the creation of a legal professional-client relationship, at 108, the client would be presented with language confirming that a legal professional-client relationship has been established. In one example, the client is further presented with a unique identifier, such as that illustrated at 110. Clients can later enter this unique identifier throughout the legal proceeding to track the status of their proceeding.

As is further illustrated in FIG. 6, the information provided by the client at steps 102, 104 and 106 would be transmitted to the server 12, and stored thereon. The server 12, in this example, communicates to the legal professional that new information is available regarding a potential new legal matter. This notification could come in the form of an alert, as illustrated at 112. The legal professional could further be alerted, or notified in some other way, such as by receiving an email, or an SMS text message. In another example, there is no notification, and the legal professional would instead regularly monitor a database for new information.

The legal professional has access to a database of entries submitted by clients, as generally illustrated at 114. The database, in one example, is hosted by the server 12, and presents the information provided by clients in the method of FIG. 2 (e.g., in the form of a spreadsheet). The lawyer can review this information and proceed with representing the client.

Accordingly, using the above described method, a potential client can directly hire a legal professional using an electronic device, such as a mobile phone. On the one hand, the legal professional can act on a particular matter without investing the time that is normally required to meet with, and bring in, new clients. On the other hand, the convenience associated with being able to hire a legal professional with minimal contact makes the idea of hiring a legal professional for certain matters, such as traffic tickets, more desirable to potential clients that would otherwise not be interested in hiring a legal professional for that particular type of matter.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A method for a legal professional to obtain a client to represent in a legal matter, comprising:
presenting a potential client with an interface allowing the potential client to input information relating to a legal matter; and
presenting the potential client with a retainer agreement, accessible via an electronic device of the potential client, such that the potential client can accept the retainer agreement and hire the legal professional via the electronic device.

2. The method as recited in claim 1, including presenting the potential client with a legal fee within the retainer agreement.

3. The method as recited in claim 2, wherein a legal professional-client relationship is formed by the client having accepted the retainer agreement and paid the legal fee.

4. The method as recited in claim 3, including presenting the client with a unique identifier for the client to track the status of the legal matter.

5. The method as recited in claim 4, including presenting an interface including a field allowing the client to enter the unique identifier, via the electronic device, and presenting the client with the current status of the legal matter.

6. The method as recited in claim 2, including presenting the potential client with an interface allowing the potential client to input payment information for payment of the legal fee.

7. The method as recited in claim 1, wherein the information concerning the legal matter includes information relating to a jurisdiction in which the potential client desires legal representation.

8. The method as recited in claim 7, wherein the retainer agreement is specific to a jurisdiction in which the potential client desires legal protection.

9. The method as recited in claim 1, wherein the information concerning the legal matter includes information relating to a traffic violation.

10. The method as recited in claim 9, wherein the information relating to the traffic violation includes a series of characters identifying a particular traffic ticket.

11. The method as recited in claim 9, wherein the information relating to the traffic violation includes an image of a traffic ticket.

12. The method as recited in claim 1, wherein the interface for the client to input information concerning the legal matter includes a field allowing the potential client to upload an image of a traffic ticket.

13. The method as recited in claim 1, wherein the electronic device is one of a computer, a mobile phone, and a tablet.

14. The method as recited in claim 1, wherein the legal professional has access to a database of entries submitted by clients.

15. A method for a legal professional to obtain a client to represent in a legal matter, comprising:
presenting a potential client with an interface, accessible via an electronic device of the potential client, allowing the potential client to input information relating to a legal matter, wherein the interface includes a field allowing the potential client to take a photo of a traffic ticket using the electronic device and to upload the photo;
presenting the potential client with a retainer agreement accessible via the electronic device, the retainer agreement including a legal fee;
presenting the potential client with an interface, accessible via the electronic device, allowing the potential client to input payment information for paying the legal fee; and
allowing the potential client to submit the payment information and accept the retainer agreement via the electronic device such that the potential client becomes a client of the legal professional.

16. The method as recited in claim 15, including transmitting the information relating to the legal matter to a server upon the potential client accepting the retainer agreement and paying the legal fee.

17. The method as recited in claim 16, including storing the information relating to the legal matter on the server.

18. The method as recited in claim 17, including notifying the legal professional that the information relating to the legal matter is available on the server.

19. The method as recited in claim 17, wherein the information relating to the legal matter stored on the server is accessible by a the legal professional.

20. The method as recited in claim 15, including presenting the client with a unique identifier for the client to track the status of the legal matter.
